(19) United States
(12) Patent Application Publication
(10) Pub. No.: US 2023/0398951 A1
(43) Pub. Date: Dec. 14, 2023

(54) BRACKET ASSEMBLY

(71) Applicant: ILLINOIS TOOL WORKS INC., Glenview, IL (US)

(72) Inventors: Scott BAIR, Skokie, IL (US); John F. HEALEY, Naperville, IL (US); Michael S. MCGUIRE, Brookfield, IL (US); Karly R. MILLER, Lemont, IL (US); Piotr SLIWA, III, Mount Prospect, IL (US)

(21) Appl. No.: 18/205,976

(22) Filed: Jun. 5, 2023

Related U.S. Application Data
(60) Provisional application No. 63/350,459, filed on Jun. 9, 2022.
(60) Provisional application No. 63/401,743, filed on Aug. 29, 2022.
(60) Provisional application No. 63/425,777, filed on Nov. 16, 2022.
(60) Provisional application No. 63/425,871, filed on Nov. 16, 2022.

(51) Int. Cl. B60R 11/04; B60S 1/02

(52) U.S. Cl. CPC B60R 11/04; B60S 1/026

(57) ABSTRACT

A bracket includes a bracket material layer, and a cell foam attached to the bracket material layer for directing heat from a heating element toward glass. The heating element is attached to the cell foam for raising a temperature of the glass disposed on or over the heating element.

### CROSS-REFERENCE TO RELATED APPLICATIONS

This application claims priority to and the benefit of U.S. provisional patent application Nos. 63/350,459; 63/401,743; 63/425,777; and 63/425,871 filed in the United States Patent and Trademark Office on Jun. 9, 2022; Aug. 29, 2022; Nov. 16, 2022; and Nov. 16, 2022, respectively, the entire contents of which are incorporated herein by reference as if fully set forth below in their entirety and for all applicable purposes.

### BACKGROUND

A vehicle camera bracket assembly can include a camera and an assembly for mounting the camera, among other electrical devices, on a windshield of a vehicle for the camera to capture object(s) or scene(s) beyond the windshield. Under some adverse weather conditions, the camera in the typical conventional camera bracket assemblies cannot properly capture object(s) or scene(s). What is needed are camera bracket assemblies, systems, and methods that address one or more of these shortcomings.

### SUMMARY

The following presents a simplified summary of one or more aspects of the present disclosure, to provide a basic understanding of such aspects. While some examples may be discussed as including certain aspects or features, all discussed examples may include any of the discussed features. Unless expressly described, no one aspect or feature is essential to achieve technical effects or solutions discussed herein.

In one aspect, a bracket includes a bracket material layer and a cell foam attached to the bracket material layer for directing heat from a heating element toward glass. The heating element is attached to the cell foam for raising a temperature of the glass disposed on or over the heating element.

In another aspect, a bracket includes a bracket material layer including a plurality of openings for directing heat from a heating element toward glass. The heating element on the bracket material layer raises a temperature of the glass disposed on or over the heating element.

In another aspect, a bracket includes a bracket material layer, an adhesive layer attached to the bracket material layer, and a fiber material layer attached to the bracket material layer via the adhesive layer for mitigating glare on the bracket material layer.

These and other aspects of the camera bracket assemblies and/or electrical circuit components discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various tools, devices, systems, and methods.

### DESCRIPTION OF THE DRAWINGS

FIG. 1A is a schematic representation of a bracket assembly according to some embodiments;

FIG. 1B is a schematic representation of the bracket assembly of FIG. 1A being attached to a windshield of a vehicle;

FIG. 2 is an isometric view of a sensor assembly of the bracket of FIG. 1A;

FIGS. 3A-3D illustrate an example assembly process of the sensor assembly taken along plane I-I′ of FIG. 2;

FIGS. 4A and 4B are schematic representations of camera brackets similar to the camera bracket in the bracket assembly of FIG. 1A;

FIG. 5 is a schematic representation of material layers of a camera bracket of a bracket assembly similar to the bracket assembly of FIG. 1A;

FIGS. 6A-6D are schematic representations of camera brackets and material layers for the example camera brackets associated with the bracket assembly of FIGS. 1A and 5;

FIG. 7A is a schematic representation of material layers of a camera bracket associated with the example bracket assembly of FIGS. 1A and 5;

FIGS. 7B and 7C are bracket material arrangements of the camera bracket of FIG. 7A;

FIG. 8 is a schematic representation of a camera bracket similar to the camera bracket in the bracket assembly of FIG. 1A;

FIGS. 9A-9D are schematic representations of material layers of camera brackets similar to the camera bracket of the bracket assembly in FIGS. 1A and 5;

FIG. 10 is a schematic representation of material layers of a camera bracket similar to the camera bracket of the bracket assembly in FIGS. 1A and 5;

FIG. 11 is a schematic representation of a camera bracket with a local energy storage unit of a bracket assembly similar to the bracket assembly of FIG. 1A;

FIGS. 12A and 12B are schematic representations of terminals of a bracket assembly similar to the bracket assembly of FIG. 1A;

FIG. 13 is a schematic representation of a terminal of a bracket assembly similar to the bracket assembly of FIG. 1A;

FIG. 14 a schematic representation of a partial, enlarged view of a bracket assembly similar to the bracket assembly of FIG. 1A; and

FIGS. 15A and 15B are schematic representations of a hinge in the bracket assembly of FIG. 1A.

### DETAILED DESCRIPTION OF THE DRAWINGS

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Throughout the disclosure, the terms “about” and “approximately” mean plus or minus 5% of the number that each term precedes.

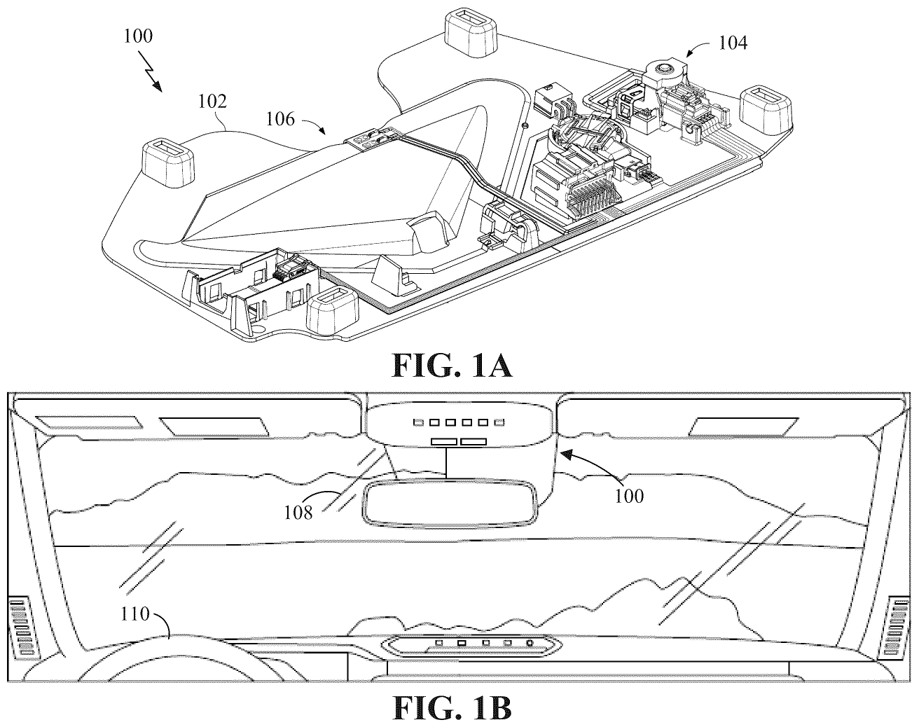

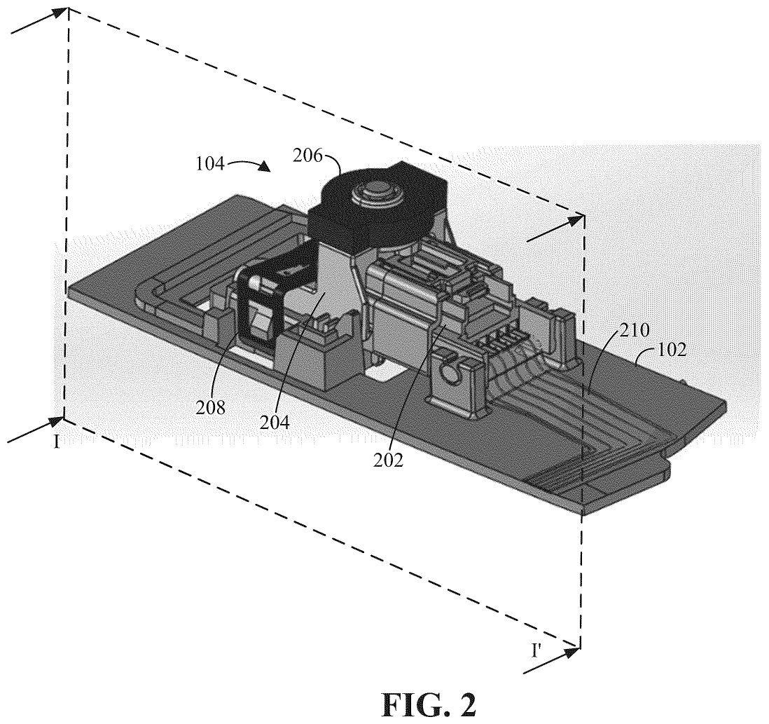

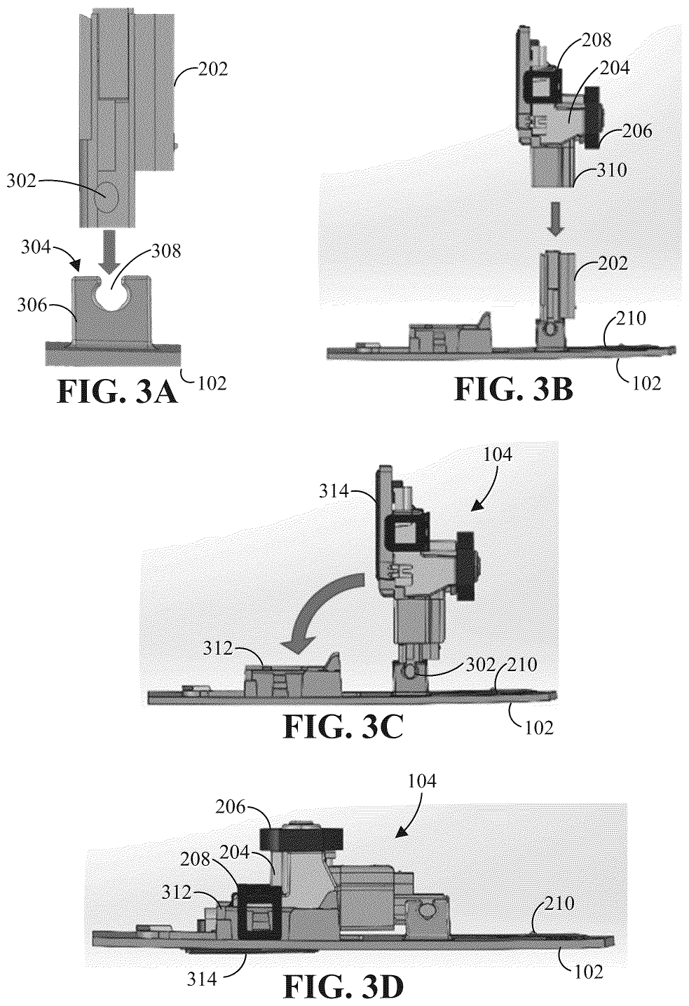

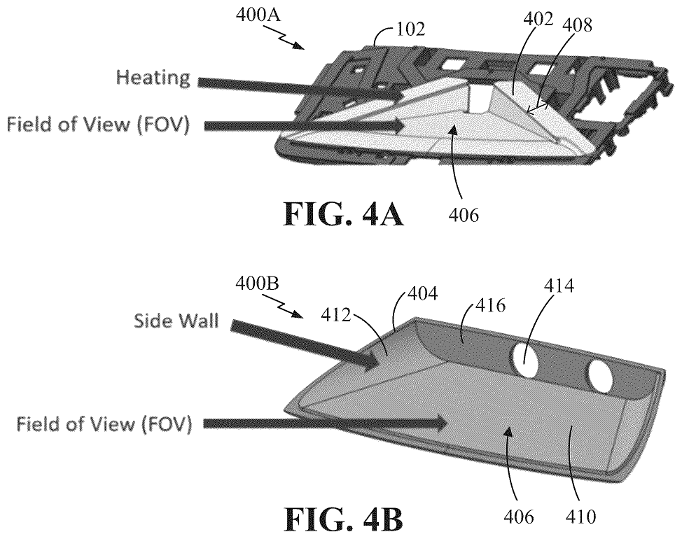

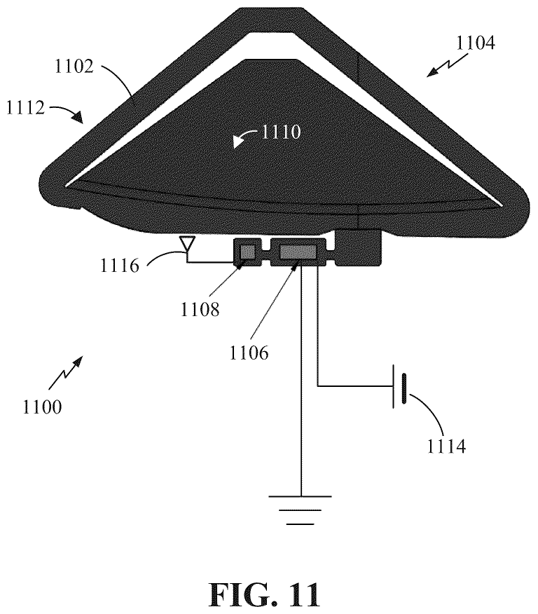

FIG. 1A depicts a bracket assembly 100 including a bracket body 102 and a sensor assembly 104 configured to be connected to the bracket body 102. The sensor assembly 104 is described in connection with FIGS. 2 and 3 below. The described embodiments of the sensor assembly 104 allow for an efficient installation and removal of an electrical device (e.g., a sensor, a camera, or any other suitable device) on or from the bracket body 102. Additionally, the bracket body 102 includes a camera bracket 106, which is described in connection with FIGS. 4-10 below. The disclosed embodiments of the camera bracket 106 include an efficient heater to effectively defrost glass and efficient anti-glare materials or their arrangements. The bracket assembly 100 can further include additional electrical components described in connection with FIGS. 11-15. The additional electrical components can increase connectivity to other electrical components and/or reusability of at least part of the bracket assembly 100.

With reference FIG. 1B, the bracket assembly 100 is attached on the glass 108 (i.e., windshield) of a vehicle 110. The bracket assembly 100 is arranged on the glass 108 such that the field of view of the camera (not shown in FIG. 1A or 1B) faces toward the glass 108 and forwardly into the vehicle's forward direction of travel. As such, the bracket assembly 100 can operate as part of, for example, a lane departure warning (LDW) system and/or an automatic emergency braking system, among other functionalities. It should be appreciated that the use case illustrated in FIG. 1B is a mere example. The bracket assembly 100 can be used in any other suitable place. For example, the bracket assembly 100 can be used in a variety of applications such as aircrafts, security systems, among other uses.

With reference to FIG. 2, the sensor assembly 104 includes a connector 202, a sensor 204, and one or more fasteners 206, 208. In some scenarios, a sensor 204 attached on a bracket body 102 may need to be replaced for a suitable reason (e.g., a malfunction, an improved sensor, an inoperable state, etc.) or may otherwise need to be accessed and/or removed. However, if the sensor 204 is permanently attached to the bracket body 102 (e.g., using a glue, a solder, etc.), it is difficult to remove or replace the sensor 204. In such scenarios, when the sensor 204 is replaced, a circuit 210 (e.g., printed circuit 210) connected to the sensor 204 can be damaged. Alternatively, the whole bracket body 102 may be damaged and need to be replaced. The sensor assembly 104 shown in FIG. 2 can address one or more of these shortcomings. For example, the sensor assembly 102 can have features for the sensor 204 to be easily replaced, for the sensor assembly 102 to be attachable and detachable to the bracket body 102, and for the sensor assembly 102 to be firmly fixed on the bracket body 102.

FIGS. 3A-3D depict an example process to assemble the sensor assembly 104. With reference to FIG. 3A, the connector 202 is configured to be connected to the bracket body 102. In some embodiments, the connector 202 includes a pivot shaft 302 to be received in a pivot receiver 304 of the bracket body 102. In further examples, the pivot shaft 302 can have an oblong shape, a circular shape, or any other suitable shape to be received in the pivot receiver 304 and rotate the connector 202 relative to the pivot shaft 302. In some examples, the pivot shaft 302 is pressed to be received in the pivot receiver 304. The pivot receiver 304 includes a protrusion 306 on the bracket body 102 and an opening 308 to receive the pivot shaft 302. In some examples, the opening 308 can have an oblong shape with an elongated body corresponding to the pivot shaft 302. Thus, the oblong shape of the opening 308 corresponds to the oblong shape of the pivot shaft 302 such that the pivot shaft 302 fits into the opening 308 when the pivot shaft 302 is pressed in the opening 308 to a direction at a right angle to the bracket body 102. However, it should be appreciated that the pivot shaft 302 and the opening 308 can have any other suitable shape (e.g., circle, polygon, etc.). In addition, it should be appreciated that the pivot shaft 302 is pressed in the opening 308 in any suitable direction based on the direction of the opening 308. For example, the pivot shaft 302 can be received in the opening 308 with a 45-degree angle, a 30-degree angle, or a 60-degree angle relative to the bracket body 102. In further examples, when the connector 202 is received in the pivot receiver 304, the circuit 210 can be connected to the connector 202. For example, the circuit 210 can be a flexible circuit and be received in the connector 202. In some examples, the connector 202 can include a suitable fastener to fasten the circuit 210 to the connector 202. In other examples, the circuit 210 can be attached on the protrusion 306 for the connector 202 to be electrically coupled when the connector 202 is fastened on the bracket body 102. For example, the connector 202 can include electrical contacts on a surface of the connector, which is configured to be in contact with the circuit 210 when the connector 202 is fastened on the bracket body 102. However, it should be appreciated that any suitable electrical coupling between the circuit 210 and the connector 202 can be used. Further, it should be appreciated that the connector 202 can include the opening 308 rather than the pivot shaft 302, and the pivot receiver 304 can include the pivot shaft 302 rather than the opening 308. In other examples, the connector 202 can be a living or integral hinge connected to the bracket body 102. In the examples, the connector 202 includes a flexible hinge connected to the bracket body 102 to be configured to receive the sensor 204.

With reference to FIG. 3B, the sensor 204 can be electrically coupled with the connector. In some examples, the sensor 204 can be pre-assembled with a sensor base 310 and the one or more fasteners 206, 208. In some examples, the one or more fasteners 206, 208 can fasten the sensor 204 to the sensor base 310. In some embodiments, the sensor base 310 can receive the connector 202 to be electrically coupled and can be fastened with the connector 202 using a suitable fastener. For example, the sensor base 310 can be pressed to the connector 202 in the same direction as the direction in which the connector 202 is pressed to the pivot receiver 304. Then, the connector 202 is received in the sensor base 310 to be connected to the sensor 204. Thus, the sensor 204 can be electrically coupled with the circuit 210 using the connector 202 and/or the sensor base 310. It should be appreciated that the connector 202 can receive the sensor base 310 to connect the sensor 204 to the circuit 210. In some embodiments, the sensor 204 can be any suitable sensor (e.g., humidity sensor, temperature sensor, vibration sensor, air-flow sensor, rain sensor, accelerometer sensor, gyroscope sensor, magnetometer, barometer, inertial measurement unit (IMU) sensor, etc.) to measure a physical property and environment surrounding the sensor. In some examples, the sensor can be attached to or near to the glass of the bracket assembly 100 in connection with FIG. 1 and measure an area within the glass where the sensor 204 is placed (e.g., inside of a vehicle) or another area outside of the glass where the sensor 204 is not placed (e.g., outside of a vehicle). The sensor 202 and one or more fasteners 206, 208 with/without the sensor base 310 constitute the assembled sensor assembly 104 in FIGS. 1 and 2.

With reference to FIG. 3C, the sensor assembly 104 can rotate relative to the pivot shaft 302 of the sensor assembly 104. In some embodiments, the bracket body 102 includes a sensor receiver 312 to receive the sensor assembly 104. In some embodiments, before the sensor assembly 104 sits on the bracket body 102, the connector 202 can be electrically coupled with the circuit 210 (e.g., by inserting the circuit 210 in the connector 202). In other embodiments, before the sensor assembly 104 sits on the bracket body 102, the connector 202 might not be electrically coupled to the circuit 210. In these embodiments, the circuit 104 is attached on the pivot receiver 304 while a surface of the circuit 210 can include electrical contacts. When the sensor assembly 104 is fastened to the bracket body 102, the electrical contacts of the connector can be in contact with the circuit 210. It should be appreciated that the sensor assembly 104 can be electrically coupled with the circuit 210 by any other suitable means.

With reference to FIG. 3D, the sensor assembly 104 sits on the sensor receiver 312 of the bracket body 102. In some embodiments, the sensor assembly 104 includes a first fastener 206 to fasten the sensor 204 to the sensor base 310, and a second fastener 208 to fasten the sensor assembly 104 to the bracket body 102. For example, the first fastener 206 can include a nut with threads inside the nut while the sensor 204 can include a bolt with threads outside the bolt. Thus, the first fastener 206 can fasten the sensor 206, which sit on the sensor base 310 by using the bolt of the sensor 204. In further embodiment, the second fastener can include a latch (e.g., pull down latch, locking latch, or any other suitable latch). While an exemplary securing mechanism has been described herein, it is contemplated that any suitable securing mechanism may be utilized to secure the sensor assembly 104 to the bracket body 102.

In some embodiments, a surface of the sensor assembly 104 can be in contact with the glass when the sensor assembly 104 is secured to the bracket body 102. Thus, the sensor 204 can measure some physical properties (e.g., outside temperature, vibration, etc.) in connection with the glass. However, it should be appreciated that the sensor 204 is not limited to measure physical properties in connection with the glass. For example, the sensor 204 can measure the temperature of the air, the humidity in the air, or any other suitable physical property in the environment surrounding the sensor 204. Thus, the pivoting motion and subsequent position change of the sensor assembly 104 enhances the ability of a user to mate the corresponding electrical/electronic device (the electrical connection) and mechanically install the device into its home position into the bracket system. In further examples, the sensor 204 can include any suitable sensor used in automotive driver assistance or autonomy systems. For example, the sensor 204 can include a light detection and ranging (LiDar) sensor, an infrared (IR) sensor, a radar sensor, or any other suitable sensor.

In some embodiments (see FIGS. 4A and 4B), camera brackets 400A, 400B are shown to include heating elements (e.g., heating plane 402 or heating edge 404). The camera brackets 400A, 400B are similar to the camera bracket 106 of FIG. 1. The heating elements increase the temperature of glass in contact with the heating elements. Also, the heating elements can cause convection of the air surrounding the fields of view 406 of cameras mounted on the camera brackets 400A, 400B. In some examples, the field of view 406 of a camera indicates an area the camera can capture between the glass and the camera mounted to the camera bracket 400A, 400B. In this way, the heating elements quickly or rapidly defrost the glass surrounding the fields of view 406 of the cameras, thereby effectively clearing the viewing areas of the cameras. In some embodiments, the heating elements include a metal heater, a ceramic heater, a semiconductor heater, a film heater, a polyimide flexible heater, a silicone flexible heater, a polyester heater, a resistive heater, a positive thermal coefficient heater, a rigid heater, an infrared heater, a transparent heater, a combination of the heaters, or any other suitable means to increase the temperature of the glass or air around the field of view 406 to clear the glass (e.g., from frost or condensation on the interior or exterior surface of the glass). Thus, the heating element provides conductive heat transfer via the portion of the heating element in contact with the glass, convective heat transfer via the portions of the heating element in contact with the air above the glare shield surface to enable defrosting of the glass, and/or radiant heat transfer from the heating element to the glass and to the frost on the glass.

With reference to FIG. 4A, the heating element in the camera bracket 106A can include a heating plane 402. The heating plane 402 is attached to the bracket body 102 surrounding the field of view 406 of a camera (not shown in FIG. 4A) to be in contact with the glass. A width 408 of the heating plane 402 from the field of view 406 is at least 2 cm. The heating plane 402 is configured to be attached to the glass and transfer the heat to the glass around the field of view 406 of the camera mounted to the camera bracket 400A.

With reference to FIG. 4B, the heating element in the camera bracket 400B can include a heating edge 404. The heating edge allows for contact with the glass without the additional space (e.g., the heating plane 402 in FIG. 4A). In the embodiments, the heating element in the camera bracket 400B includes the heating edge 404. The heating edge 404 is attached on the glare shield 410, the sidewall 412, and/or the back support 416. In some embodiments, a width of the heating edge 404 from the field of view 406 in contact with the glass is less than 5 mm. In further embodiments, the width of the heating edge 404 can be the shortest length of the heating edge 404 from the field of view 406 to the outside of the field of view 406. The camera bracket 400B can be attached to the glass at the heating edge 404 to transfer the heat directly to the glass. In some examples, the heating edge 404 can be a strip attached on the perimeter of the field of view 406 and attached on the edges of the glare shield 410, the sidewall 412, and/or the back support 416, which are/is exposed to the glass.

With reference to FIG. 4B, the heating element can include a heating pad attached on a surface of the sidewall 412, the glare shield 410, and/or the back support 416. The surface of the sidewall 412, the glare shield 410, and/or the back support 416 is a surface that is exposed or is not exposed to the field of view 406. In the illustrated embodiments, an edge of the heating pad (i.e., heating edge 404 of the camera bracket 400B) is configured to be in contact with the glass and transfer the heat to the glass to defrost the glass and/or transfer the heat indirectly to the glass via the open area or the field of view 406 between the glass and the surface of the sidewall 412 and/or the glare shield 410. In further examples, the heating pad can wrap around the edge of the glare shield 410, the sidewall 412, and/or the back support 416, which are/is exposed to the glass. The heating edge 404 can include a part of the heating pad wrapping around the edge of the glare shield 410, the sidewall 412, and/or the back support 416 where the edge of the heating pad is configured to be in contact with the glass. In further embodiments, the heating pad extends to the entire glare shield 410, the entire sidewall 412, and/or the entire back support 416 to increase the temperature of the air of the field of view 406 to defrost the glass. Thus, the edge of the heating pad is utilized to reduce the space around the perimeter of the field of view 406 to be in contact with the glass and/or increase the temperature of the air in the field of view 406. Although the heating element's space in contact with the glass is substantially reduced, the performance (e.g., time) to defrost the glass has not been compromised.

Referring back to FIG. 4B, the camera bracket 400B can further include a glare shield 410 and a sidewall 412 connected to the glare shield 410. The glare shield 410 and the sidewall 412 define the field of view 406 of the camera (not shown in FIG. 4B). In some embodiments, the camera bracket 400B can further include a hole 414 to mount the camera to the camera bracket 400B. In further embodiments, the hole 414 can be disposed on a back support 416. The back support 416 can include more than one hole 414 to mount more than one camera to the camera bracket 400B. In other embodiments, the hole 414 can be disposed between two side walls as shown in FIG. 4A. In some examples, the glare shield 410 can have a substantial triangular shape, a trapezoidal shape, or any other suitable shape to provide a sufficient field of view of the camera mounted on the camera bracket 400B. In further examples, the glare shield 410 can be flat or curved. In even further examples, the glare shield 410 can include one or more louvers (e.g., simple parallel surfaces, or specifically arrayed surfaces such that no light contacting the width of each louvre can reflect to the sensor lens). Thus, an incident light ray passing the glass attached on the camera bracket 400B can be absorbed or diffused on the one or more louvers to prevent the light ray from reflecting into a lens of the camera. In some examples, the sidewall 412 can have a substantial triangular shape, a trapezoidal shape, or any other suitable shape. In further examples, the sidewall 412 can be flat or curved.

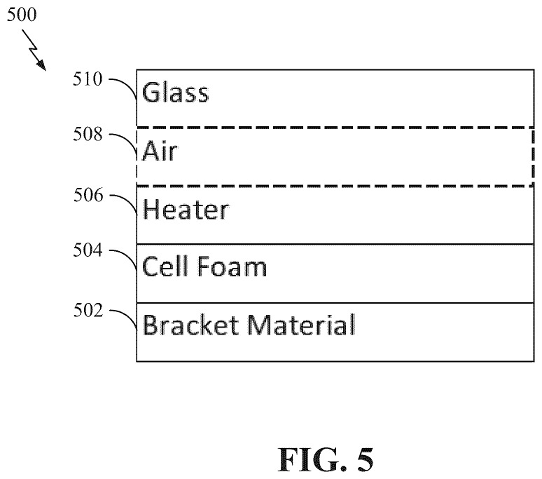

With reference to FIG. 5, an exemplary embodiment of the various material layers 500 in a bracket associated with the bracket assembly of FIG. 1A are illustrated to direct more heat toward glass or air with less heat loss, for example, through the bracket and/or into the vehicle. In some embodiments, the bracket 106 includes a bracket material layer 502 and a cell foam 504 attached to the bracket material layer for directing heat from a heating element 506 toward glass. In some examples, the bracket 106 can further include a heating element 506 adjacent the cell foam 504. In some examples, the heating element 506 can be attached to the cell foam 504 for raising a temperature of the glass 510 disposed on or over the heating element.

In some embodiments, the bracket material layer 502 of the bracket 106 can be made of a polymer material (e.g., a thermoplastic material). However, it should be appreciated that the bracket material layer 502 can be made of any other suitable material (e.g., metal material). In further embodiments, the bracket material layer 502 can be used in other components (e.g., in the bracket assembly 100 of FIG. 1).

In some embodiments, the heating element 506 can include the heating plane 402 in connection with FIG. 4A, the heating edge 404 in connection with FIG. 4B, and/or the heating pad 418 in connection with FIG. 4C. The heating element 506 can include a metal heater, a ceramic heater, a semiconductor heater, a film heater, a polyimide flexible heater, a silicone flexible heater, a polyester heater, or any other suitable heater to increase the temperature of the air 508 (e.g., field of view 406 of FIG. 4B) or the glass 510 to clear the glass 510 (e.g., from frost or condensation). In some examples, the glass is disposed over the heating element to heat the glass by transferring heat from the heating element to the glass by convection. For example, when the heating element 506 is on a glare shield or a sidewall of the bracket 106 (e.g., the glare shield 410 or the sidewall 412 of FIG. 4B), the air 508 is placed between the glass 510 and the heating element 506 to increase the temperature of the air 508 and/or the glass 510 around the field of view 406 of FIG. 4B. In other examples, the glass is disposed on the heating element to heat the glass by conduction. For example, when the heating element 506 is on the sidewall of the bracket 106 (e.g., the sidewall 412 of FIG. 4B), the heating element 506 can be in contact with the glass 510 without the air 508 between the heating element 506 and the glass 510.

In some embodiments, a cell foam 504 can be disposed between the heating element 506 and the bracket material layer 502 to direct heat to the air 508 and/or the glass 510 rather than to the bracket material layer 502. The cell foam 504 can have a predefined thickness as an insulator to suppress absorption of the heat from the heating element 506. In some examples, the cell foam 504 can be made of a rubber compound or any other suitable material. In some examples, the cell foam 504 can be at least one of a closed cell foam or an open cell foam. The closed cell foam includes multiple isolated pores. In some examples, a pore in the closed cell foam can include gas (e.g., nitrogen) and can be completely surrounded by a solid material (e.g., rubber). Thus, the closed pore structure including the gas within the pores of the closed cell foam can provide insulation to prevent the heat of the heating element 506 from being directed to the bracket material layer 502. However, the pores are too small to be observed by a person. The closed cell foam can be considered to have a uniform or solid surface. In further examples, the cell foam 504 can be a closed cell foam with one or more pockets to create a non-uniform surface. The pocket can be generated by removing material from the closed cell foam such that the surface of the closed cell foam is not uniform. Thus, the material used for the closed cell foam can be reduced by making multiple pockets on and/or in the closed cell foam. In some embodiments, a pocket can include air within or on the closed cell foam as an insulator. In further embodiments, the pocket can be a closed pocket, which is completely surrounded by the solid material, or an open pocket, which includes an opening exposed to the air. Due to the pockets on the surface of the closed cell foam, the closed cell foam may not be uniform. In further examples, the cell foam 504 can be an open cell foam. The open cell foam includes multiple connected pores. The pores in the open cell foam are connected to each other. The open cell foam filled with gas (e.g., air) can be an insulator to direct the heat from the heating element 506 to the air 508 and/or the glass 510.

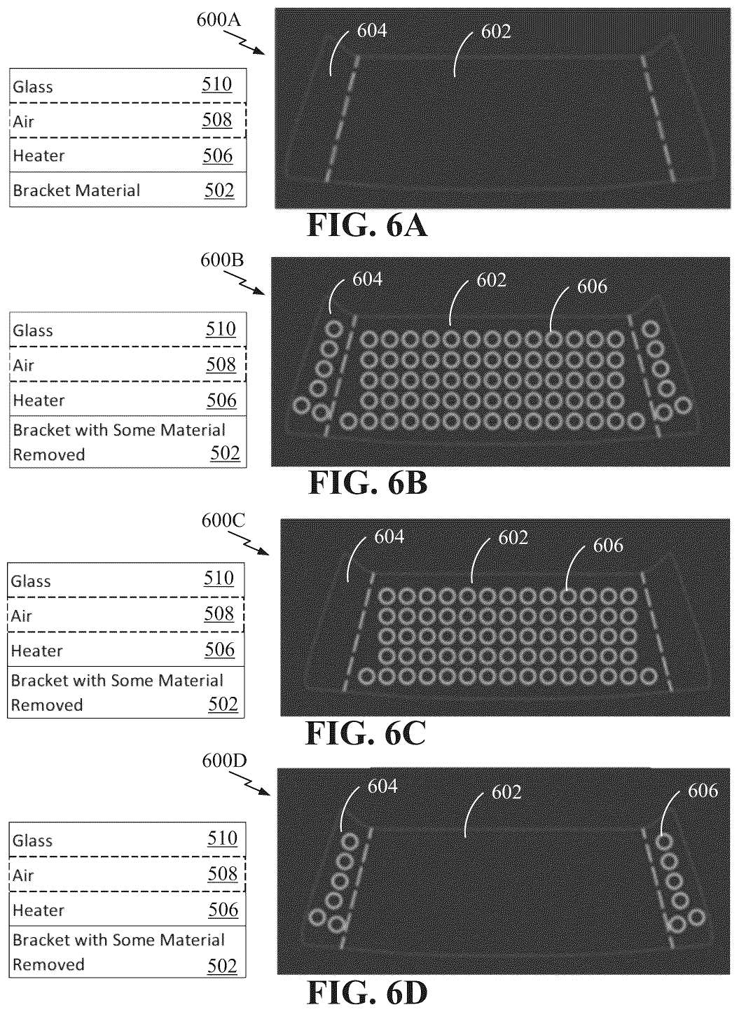

In some embodiments shown in FIGS. 6A-6D, the heating element 506 can be directly attached to the bracket material layer 502. The material layers of the bracket 600A-600D, namely the bracket material layer 502, the heating element 506, the air 508, and/or the glass 510 in FIGS. 6A-6D, are substantially similar to the bracket material layer 502, the heating element 506, the air 508, and the glass 510 in FIG. 5. In some examples, the bracket 600A-600D can include a bracket material layer 502 including multiple openings for directing heat from a heat element 506 toward glass 510. In further examples, the heating element 506 can be disposed on the bracket material layer 502 for raising a temperature of the glass 510 disposed on or over the heating element 506. With reference to FIG. 6A, the bracket 600A-600D can further include an adhesive (not shown in FIG. 6A) attached between the heating element 506 and the bracket material layer 502 for directing the heat from the heating element 506 toward the glass 510. The adhesive can be an insulator to direct the heat from the heating element 506 to the air 508 and/or the glass 510. In further embodiments, the adhesive can include a pressure-sensitive adhesive, an adhesive tape, an epoxy adhesive, a polyolefin adhesive, a polyurethane adhesive, or any other suitable thermal insulation adhesive. In further embodiments, the heating element 506 can be installed on the glare shield 602 and the sidewall 604 of the bracket 600A-600D, which are similar to the glare shield 410 and the side wall 412 of the bracket 400B in FIG. 4B. In the embodiment shown in FIG. 6A, the glare shield 602 and the sidewall 604 are uniform without any aperture in the glare shield 602 and the sidewall 604.

With reference to FIGS. 6B-6D, an adhesive (not shown in FIGS. 6B-6D) can be added between the heating element 506 and the bracket material layer 502 to attach the heating element 506 to the bracket material layer 502. Additionally or alternatively, each opening of the multiple openings in the bracket material layer 502 can include an aperture passing through the bracket material layer 502 and the heating element 506. In some examples, multiple apertures 606 formed by removing bracket material layer 502 can be disposed in both of the glare shield 602 and the sidewall 604 of a bracket 600B as shown in FIG. 6B, the glare shield 602 and not in the sidewall 604 of a bracket 600C as shown in FIG. 6C, or the sidewall 604 and not in the glare shield 602 of a bracket 600D as shown in FIG. 6D. In some embodiments, an apertures 604 are placed in the bracket material layer 502 such that air can flow through the apertures 606 in the glare shield 602 and/or the sidewall 604. Thus, the heating element 506 can be exposed to the air via the apertures in the glare shield 602 and/or the sidewall 604. In further embodiments, the apertures 606 can be placed in the glare shield 602 and/or the sidewall 604. In some examples, any of the apertures 606 can have a cylinder shape, a tapered polygonal prism, or any other suitable shape. The apertures 606 can also have the same shape or different shapes. In further examples, the number and location of the apertures 606 can be different depending on areas of the glare shield 602 and/or the sidewall 604 to transfer more or less heat to the air 508 and/or the glass 510 around the apertures 606.

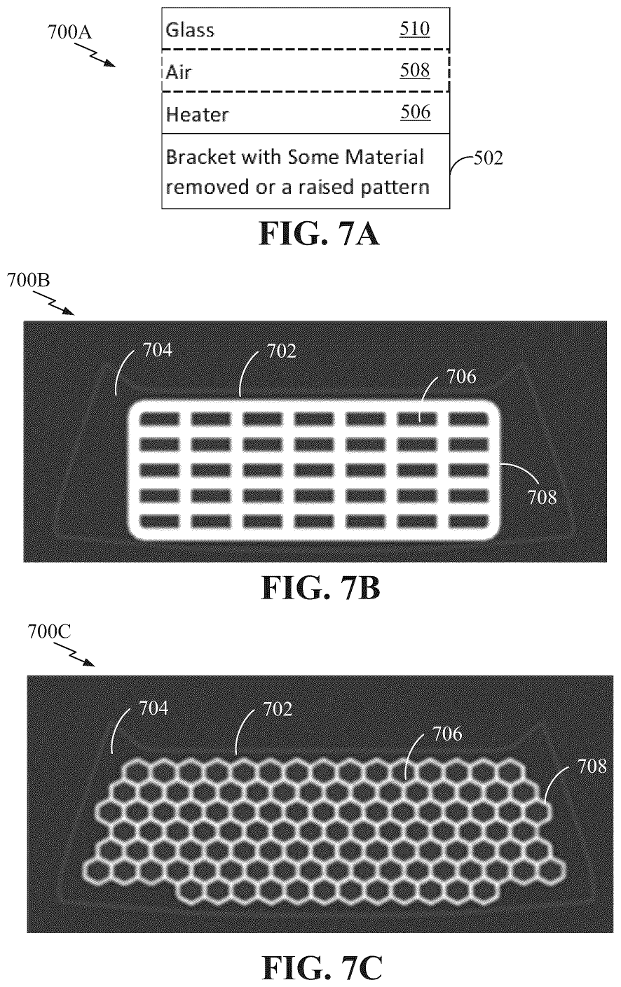

With reference to FIGS. 7A-7C, the heating element 506 can be directly attached to the bracket material layer 502. Among the material layers of the bracket 700A, the bracket material layer 502, the heating element 506, the air 508, and the glass 510 in FIG. 7A are substantially similar to the bracket material layer 502, the heating element 506, the air 508, and the glass 510 in FIG. 5. In some examples, the bracket layer 502 can include multiple openings for directing heat from the heating element 506 toward the glass 510. In some examples, each opening can include a cavity on a surface of the bracket material layer 502. In further examples, the surface of the bracket material layer 502 can be disposed on the heating element 506. In some examples, the bracket material layer 502 can include a glare shield panel 702 and/or a side wall attached to the glare shield panel 702. In some examples, the multiple openings can be disposed on at least one of the glare shield panel 702 or the side wall 704. For example, the bracket material layer 502 can be removed from the glare shield panel 702 and/or the sidewall 704 to make multiple openings 706 on the glare shield panel 702 and/or the sidewall 704 to form multiple corresponding cavities. In some examples, the cavity does not pass through the bracket material layer 502 and/or the heating element 506. In some embodiments, the glare shield panel 702 and the sidewall 704 of the bracket 700B, 700C are similar to the glare shield 410 and the side wall 412 of the bracket 400B in FIG. 4B.

In some embodiments, an opening 706 is a space in the glare shield panel 702 or the sidewall 704 where the bracket material layer 502 is partially removed from the glare shield panel 702 or the sidewall 704. Thus, the opening 706 does not pass from one surface of the glare shield panel 702 or the sidewall 704 to the opposite surface. In other embodiments, the bracket material layer 502 can further include multiple ribs on a surface of the bracket material layer 502. In some examples, the openings 706 can be formed by multiple ribs 708 (e.g., placing multiple ribs 708 on the glare shield panel 702 or the sidewall 704). In some examples, the multiple ribs of the bracket material layer 502 can be attached to the heating element 506 such that the heating element 506 contacts only a surface of the multiple ribs rather than the glare shield panel 702 or the sidewall 704. It should be appreciated that any of the openings 706 formed by ribs may be a rectangular shape or any other suitable shape. In further examples, the openings 706 can have a grid shape as shown in FIG. 7B, a honeycomb shape as shown in FIG. 7C, or any suitable shape. It should be appreciated that any of the openings 706 may be a hexagon, a polygon shape, or any other suitable shape.

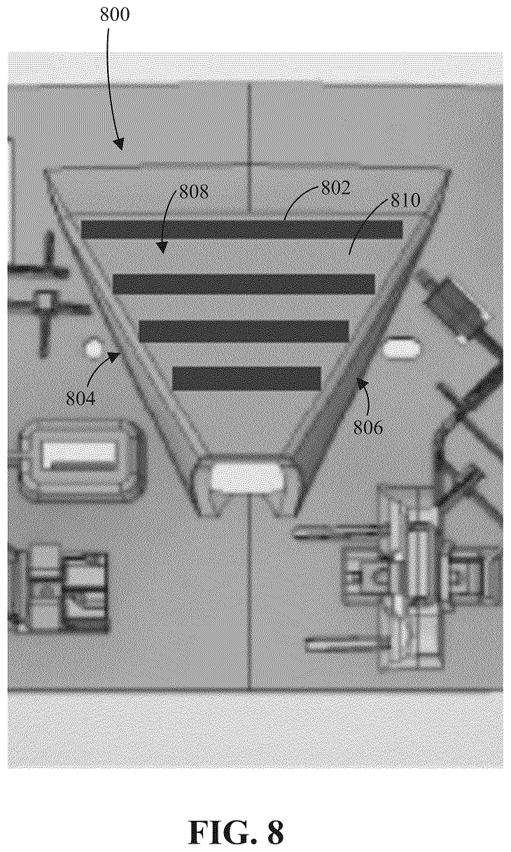

With reference to FIG. 8, another embodiment of the bracket 800 can include one or more louvers 802 for glare mitigation. In some embodiments, the one or more louvers 802 can extend across the bracket 800 from the first edge 804 to the second edge 806. The louvers 802 can protrude outward from a glare shield 808 of the bracket 106C at an angle. The louvers 802 can be integrally formed in the bracket 106C, for example, by a molding process. Slits 810 are formed in the glare shield 808 by the louvers 802. The slits 810 are configured to allow air and light to pass through the glare shield 808. The addition of one or more louvers 802 formed in the glare shield 808 can reduce reflection of light off of the glare shield 808. Additionally, the one or more louvers 802 can allow for increased circulation of air within and in and out of the glare shield 808.

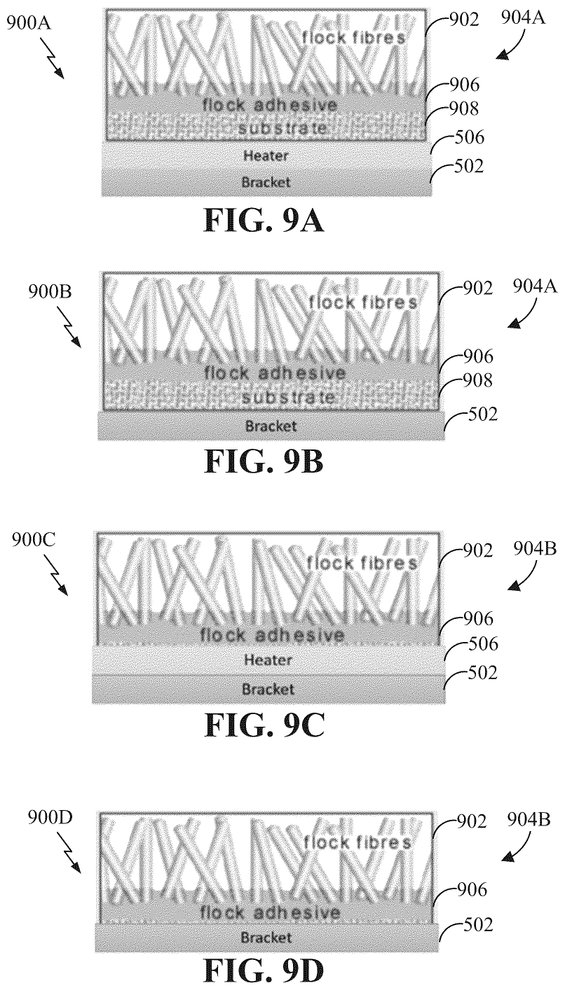

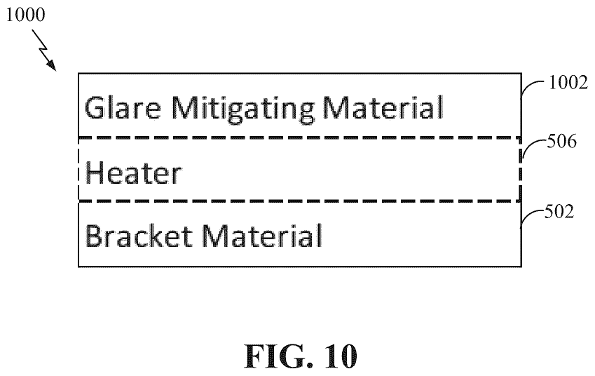

With reference to FIGS. 9A-9D and 10, the bracket 900A-900D, 1000 can include a bracket material layer 502, an adhesive layer 906 attached to the bracket material layer 502, and a fiber material layer (e.g., a flock fiber material 902 in FIGS. 900A-900D and a glare mitigating material 1002 in FIG. 10). The fiber material layer 902, 1002 can be attached to the bracket material layer 502 via the adhesive layer 906 for mitigating glare on the bracket material layer 502. In some examples, the fiber material layer can include the flock fiber material 902 in FIGS. 900A-900D. In other examples, the fiber material layer can include the other non-flock fiber material 1002 in FIG. 10.

With reference to FIGS. 9A-9D, example material layers of brackets 900A-900D can prevent stray light from entering the cameras mounted on the brackets 106. The brackets 900A-900D are similar to the bracket 106 of bracket assembly 100 in FIG. 1A. In some embodiments, the flock material layer 904A, 904B can include flock fiber material 902 shown in FIGS. 9A-9D, which can be used in a glare shield and/or a sidewall of the brackets 900A-900D (e.g., the glare shield 410 and/or the sidewall 412 of the bracket 400B shown in FIG. 4B) for glare mitigation. In some examples, the flock fiber material 902 can be made of cotton, rayon, nylon, polyester, polyamide, viscose, or any other suitable flock material. With reference to FIG. 9A, the bracket 900A can include a bracket material layer 502, a heating element 506, and a flock material layer 904A. Among the material layers of the bracket 900A, the bracket material layer 502 and the heating element 506 in FIG. 9A are substantially similar to the bracket material layer 502 and the heating element 506 in FIG. 5. In some examples, the heating element 506 can be disposed between the bracket material layer 502 and the adhesive layer 906. In further examples, the heating element 506 on the bracket material layer 502 can raise a temperature of the glass disposed on or over the heating element 506. In some embodiments, the flock material layer 904A can include flock fiber material 902, a flock adhesive 906, and a substrate 908. The flock fiber material 902 can be attached to the substrate 908 via the flock adhesive 906. The flock material layer 904A can be attached onto the heating element 506. In some embodiments, the flock material layer 904A can be used on the glare shield 410 and/or the sidewall 412 (shown in FIG. 4B) of the bracket 106 to mitigate glare in the bracket 106.

With reference to FIG. 9B, another embodiment of the bracket 900B can include a bracket material layer 502 and a flock material layer 904A. Unlike the bracket 900A in FIG. 9A, the bracket 106 in FIG. 9B does not include the heating element 506. Thus, the flock material layer 904A is directly attached to the bracket material layer 502. In some embodiments, the flock material layer 904A includes flock fiber material 902, a flock adhesive 906, and a substrate 908.

With reference to FIG. 9C, another embodiment of the bracket 900C can include a bracket material layer 502, a heating element 506, and a flock material layer 904B. In the embodiment of FIG. 9C, the flock material layer 904B includes flock fiber material 902 and a flock adhesive 906 without a substrate. Thus, the flock adhesive 906 of the flock material layer 904B in FIG. 9C is directly attached to the heating element 506.

With reference to FIG. 9D, another embodiment of the bracket 900D can include a bracket material layer 502 and a flock material layer 904B. Unlike the bracket 106 in FIG. 9C, the bracket 900D in FIG. 9D does not include the heating element 506. Thus, the flock material layer 904B is directly attached to the bracket material layer 502. In some embodiments, the flock material layer 904A includes flock fiber material 902 and a flock adhesive 906 without a substrate 908. Thus, the flock adhesive 906 of the flock material layer 904B in FIG. 9D is directly attached to the bracket material layer 502.

With reference to FIG. 10, a glare mitigation material 1002 other than the flock material (of FIGS. 9A-9D) can also prevent stray light from entering the cameras on the brackets 106. In some embodiments, the example material layers for the bracket 1000 can be used in a glare shield and/or a sidewall of the bracket 1000 (e.g., the glare shield 410 and/or the sidewall 412 of the bracket 400B shown in FIG. 4B) for glare mitigation. The bracket 1000 can include a bracket material layer 502, a heating element 506, an adhesive layer, and/or a glare mitigating material 1002. Among the material layers of the bracket 106, the bracket material layer 502 and the heating element 506 in FIG. 10 are substantially similar to the bracket material layer 502 and the heating element 506 in FIG. 5. In some examples, the fiber material layer can include the glare mitigating material 1002. The fiber material layer can include a coating layer (e.g., paint, ink, etc.) on the bracket material layer 502 to mitigate the glare. In other examples, the fiber material layer can include at least one of a felt fiber material, a non-woven material, a microfiber material, a cloth fiber material, or any other suitable material to reduce stray light entering the camera mounted on the bracket 106. In some examples, the glare mitigating material 1002 can be attached on the heating element 506, which is attached on the bracket material layer 502. In other examples, the glare mitigating material 1002 can be directly attached on the bracket material layer 502 without using the heating element 506 between the glare mitigating material 1002 and the bracket material layer 502. In further embodiments, the glare mitigating material 1002 can be applied on the surface of the glare shield and/or the sidewall of the brackets 1000.

With reference to FIG. 11, a bracket heating system 1100 operates a heating element 1102 of a camera bracket 1004 at an optimized power level to achieve fast defrost and/or minimum total power consumption regardless of supply current limitations. In some embodiments, the camera bracket 1004 is similar to the camera bracket 106 in FIG. 1A. Although some advanced driver assistance systems (ADAS) heaters can defrost the windshield of a vehicle, the time for an ADAS heater to heat and clear the field of view for a sensor is directly influenced by the heating power of the system, which is limited by the electrical power available to the heater. In most ADAS heating systems, the available current flow is restricted due to wiring system capacity or the standard automotive direct current electricity (e.g., 12 v to 13.5 v). This supply current limitation results in limited availability of energy (especially in the case of vehicles with a battery electric power train). However, the defrosting system uses an energy conversion process from electrical energy to thermal energy, which is transferred via conduction, infrared radiation, or convection to/through the glass to the frost. Since the heat of fusion (the energy required to transition a substance from solid to liquid) of the frost is a constant which is sometimes more than the wiring system capacity, the power for the ADAS defrost system is limited and would not have an optimum power level to efficiently deliver the thermal energy to the frost. The bracket heating system 1100 can address one or more of these shortcomings.

The bracket heating system 1100 includes the heating element 1102 on or in the camera bracket 1004, a local energy storage unit 1106, and a local integrated controller 1108. In some embodiments, the camera bracket 1104 includes the heating element 1102, a glare shield 1110, and/or a sidewall 1112. In some embodiments, the glare shield 1110 and the side wall 1112 of the camera bracket 1104 are substantially similar to the glare shield 410 and the side wall 412 of the camera bracket 400B in FIG. 4B. The heating element 1102 is attached on the glare shield 1110 and/or the sidewall 1112 of the camera bracket 1104. In some examples, the heating element 1102, the glare shield 1110, and the sidewall 1112 in FIG. 11 are substantially similar to the heating element 402, 404, the glare shield 1110, and the sidewall 1112 in FIG. 4B. The heating element 1102 is electrically coupled with a local energy storage unit 1106 and is controlled by a local integrated controller 1108.

In some embodiments, the local energy storage unit 1106 using the integrated controller 1108 can collect energy via limited current power connection 1114 (e.g., +12.5 v direct current electricity) during vehicle operation or vehicle charging. In further embodiments, the integrated controller 1108 can operate the heating element 1102 (e.g., based on environmental conditions, local sensor inputs, and/or signals received via network communication 1116). The local energy storage unit 1106 can directly provide power to the heating element 1102. Thus, the heating element 1102 does not need to be restrained by the limited wiring capacity to support the maximum level of current or the predefined direct current electricity provided by a main energy storage unit 1114. The local energy storage unit 1106 can provide increased power to the heating element 1102 to reduce the defrost time or provide reduced power to the heating element 1102. Thus, the local energy storage unit 1106 using the integrated controller 1108 can provide adaptable and optimized power to the heating element 1102 using collected energy using the predefined direct current electricity. In some embodiments, the local energy storage unit 1106 can be any type of battery (e.g., FiFePo, NiMH, etc.) or any type of capacitor, super capacitor, capacitor/battery hybrid, or any other suitable means to store energy.

In further embodiments, the integrated controller 1108 can calculate the optimum level of power and control the power level to be provided from the local energy storage unit 1106 to the heating element 1102. For example, the integrated controller 1108 can calculate the optimum level of power based on any suitable parameters (e.g., outside temperature, inside temperature, thickness of the glass to be defrosted, type of the glass, time, location, etc.). In some examples, the integrated controller 1108 can include a suitable network communication (e.g., local interconnect network (LIN) communication, controller area network (CAN) communication, etc.) to send and receive information from other vehicle systems (exterior temperature, interior temperature, battery state of charge, energy consumed, etc.). The integrated controller 1108 can further receive external control signals by other vehicle systems and/or configure cooperative control with other vehicle systems.

In further embodiments, the bracket heating system 1100 can further include a photovoltaic element (not shown in FIG. 11) that can deliver energy to the local energy storage unit 1106. Thus, at least part of the thermal energy generated to be used to defrost the glass can be stored in the local energy storage unit 1106 to be exploited for suitable purposes.

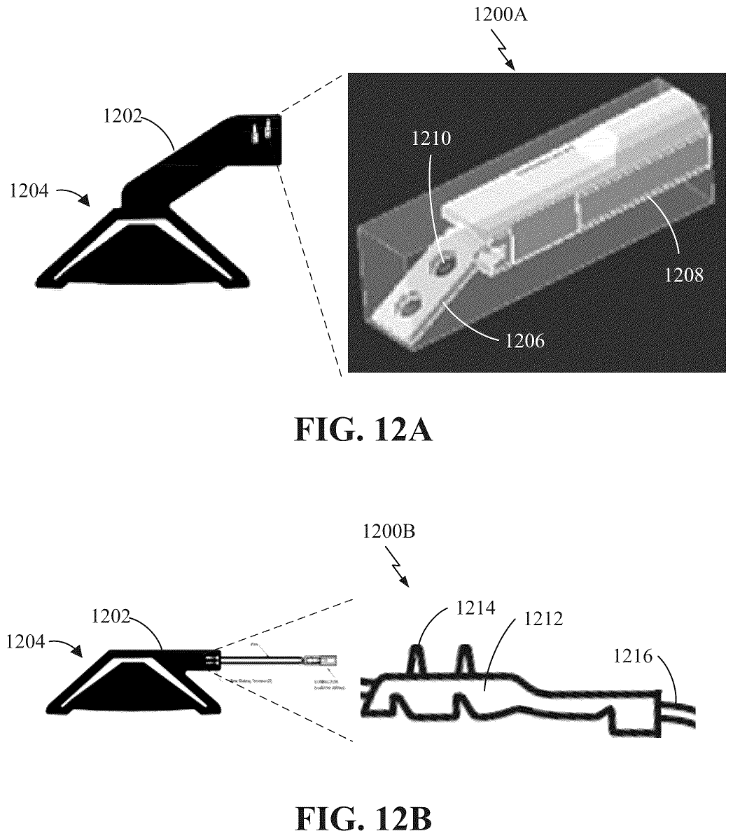

With reference to FIG. 12A, a terminal 1200A is configured to connect and disconnect a heating element 1202 of a camera bracket 1204 to an electrical component. In some embodiments, the camera bracket 1204 and the heating element 1202 is similar to the camera bracket 106 in FIG. 1A and the heating element 402, 404, 418 in FIGS. 4A-4C, respectively. In some embodiments, the terminal 1200A includes a connector 1206 and a socket 1208. The connector 1206 is configured to be connected to the heating element 1202. For example, the heating element 1202 includes a flexible substrate and with a conductive trace. In some embodiments, the connector 1206 of the terminal 1200A can be attached to the flexible substrate to provide electrical current to the conductive trace of the heating element 1202 from a power source). To facilitate the connection of the connector 1206 to the flexible substrate, the connector 1206 can include a flat conductive sheet with one or more holes 1210. For example, the one or more holes 1210 can be fastened to one or more conductive protrusions connected to the conductive trace of the heating element 1202. The connector 1206 can be made of any suitable conductive material(s) (e.g., aluminum, steel, iron, gold, silver, etc.). The connector 1206 is connected to the socket 1208 to receive or provide current and/or electrical signals from or to the socket 1208. The socket 1208 is configured to electrically connect and disconnect (e.g., be removable) to an electrical component (e.g., one or more of a wire, a wire harness, etc.). Thus, the electrical conductor can be fastened to the terminal 1200A and can be removable from the terminal 1200A at the same time. For example, the socket 1208 can receive a wire harness connecting multiple wires to provide current from the multiple wires to the heating element 1202. In further embodiments, the socket 1208 can use a suitable locking mechanism such as a snap-fit, a latch, a locking tang, etc. to firmly fix the electrical conductor to the socket 1208 and be able to disconnect the electrical conductor to the socket 1208. In other embodiments, the connector 1206 can connect to the electrical component to receive current from a power source while the socket 1208 can connect to the heating element 1202 to provide the current to the conductive trace of the heating element 1202. It should be appreciated that the terminal 1200A is not limited to connection to the heating element 1202. For example, the terminal 1200A using the socket 1208 can electrically connect or disconnect to any suitable electrical component.

With reference to FIG. 12B, a terminal 1200B can be configured to permanently connect the heating element 1202 in the camera bracket 1204 to an electrical component. In some embodiments, the terminal 1200B includes a base 1212 and one or more tines 1214 (e.g., sharp protrusions) connected to the base 1212. The one or more tines 1214 can pierce a flexible substrate of a heating element 1202 for the base 1212 or the one or more tines 1214 to be in contact with the conductive trace of the heating element 1202. After the piercing operation is complete, the one or more tines 1214 can be folded to secure the connection of the base 1212 or the one or more tines 1214 to the conductive trace of the heating element 1202. In some embodiment, the base 1212 of the terminal 1200B is placed on one surface of the heating element 1202 while the folded one or more tines 1214 are placed on the opposite surface of the heating element 1202 to fasten the terminal 1200B to the heating element 1202. In further embodiments, the one or more tines 1214 are folded toward the base 1212 or toward the outside of the base 1212. In further embodiments, the terminal 1200B can be made of any suitable conductive material(s) (e.g., aluminum, steel, iron, gold, silver, etc.). In further embodiments, the terminal 1200B is attached to one or more wires 1216 to carry current from a power source. In even further embodiments, the terminal 1200B can be also used to connect to the electrical component (e.g., a power source). It should be appreciated that the terminal 1200B is not limited to connection to the heating element 1202. For example, the terminal 1200B can electrically connect two or more conductive traces on any suitable circuit carrier (e.g., flexible substrate).

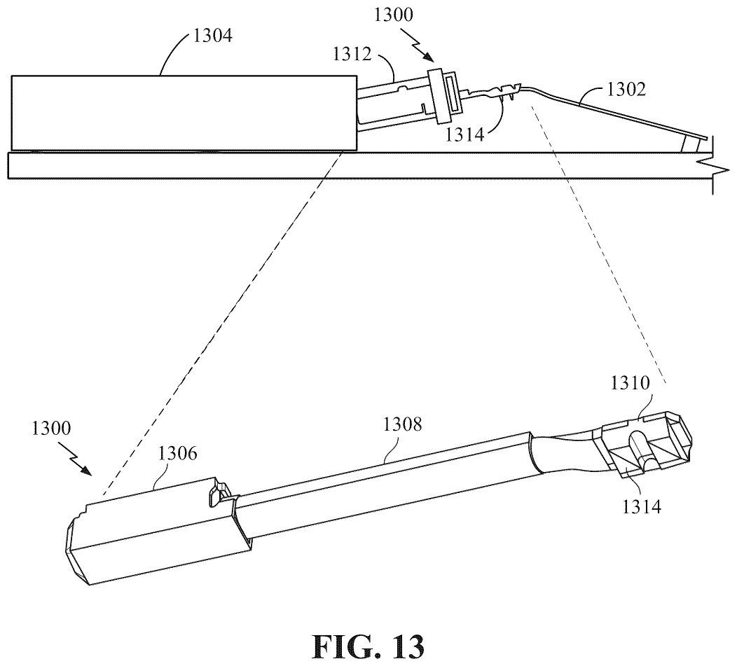

With reference to FIG. 13, a terminal 1300 can be configured to electrically connect a flexible substrate 1302 (e.g., heating element of the camera bracket 106 in FIG. 1A) to an electrical component 1304 (e.g., a power source) without using wires. In some embodiments, the terminal 1300 includes a connecting end 1306, a midsection 1308, and a crimping end 1310. The connecting end 1306 can be received by or receive a housing 206, which is connected to the electrical component 1304. The midsection 1308 can provide the necessary mechanical integrity to prevent damage to the terminal 1300 without wires between the connecting end 1306 and the crimping end 1310. Thus, the midsection 1308 can prevent fatigue and breaking of the connection between the connecting end 1306 and the crimping end 1310. The crimping end 1310 includes one or more tines 1314 to fasten the terminal 1300 to the flexible substrate 1302. In some embodiments, the crimping end 1302 is substantially similar to the terminal 1200B in FIG. 12B. In some embodiments, the connecting end 1306, the midsection 1308, and the crimping end 1310 are conductive and formed as a single, unitary component. In other embodiments, the connecting end 1306, the midsection 1308, and the crimping end 1310 are separate components to be assembled together. The terminal 1300 is used in a bracket assembly similar to the bracket assembly of FIG. 1A. However, it should be appreciated that the terminal 1300 is not limited to the bracket assembly. The terminals 1300 can be used for any electrical connection.

In some examples, an electrical connector can electrically connect two or more conductive traces on a flexible substrate (e.g., a heating element of a camera bracket). In some embodiments, the electrical connector has a circular shape, a rectangular shape, a polygonal shape, or any suitable shape. The electrical connector is made of a conductive material and can be positioned on two or more overlapping conductive traces. Then, a force is applied in one direction toward the conductive traces. In some embodiments, a fixture can be disposed underneath the conductive traces to form a bottom side of the electrical connector such that the conductive traces and the electrical connector are electrically and mechanically fastened together as one. In further embodiments, the electrical connector can be used to create an electrical circuit between two flexible substrates by pressing the two flexible substrates by the electrical connector on one flexible substrate and the fixture on the other flexible substrate.

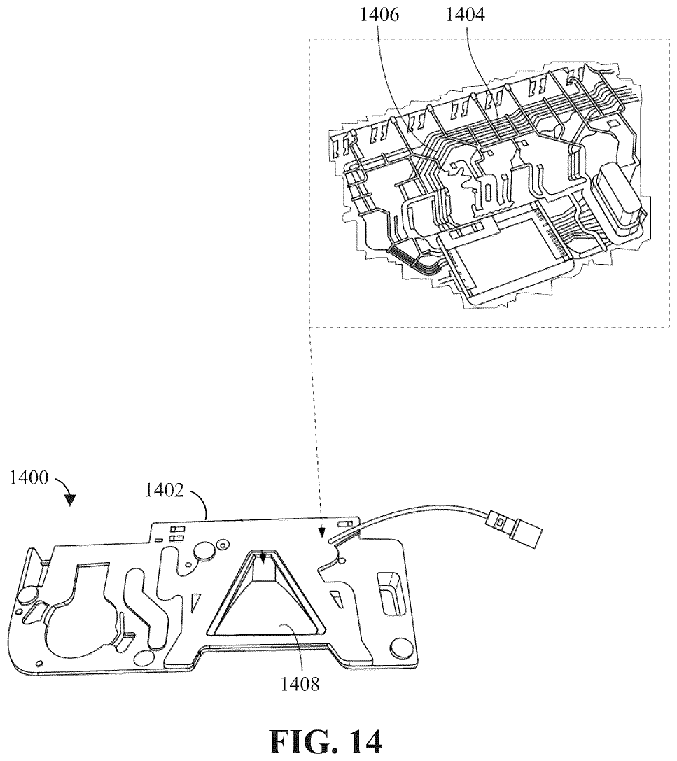

With reference to FIG. 14, another embodiment of a bracket assembly 1400 having a bracket body 1402 with leads 1404 applied to or formed on the bracket body 1502 is shown. The bracket assembly 1400 is substantially similar to the bracket assembly 100 (see FIG. 1) except for the components discussed herein. The leads 1404 of the bracket assembly 1400 form a circuit 1406 on the bracket body 1402 for establishing electrical connections among electrical devices (e.g., a rain sensor, a camera, a heating element, etc.). In further embodiments, the leads 1404 are connected to the heating element to control the heating element (e.g., in a camera bracket 1408).

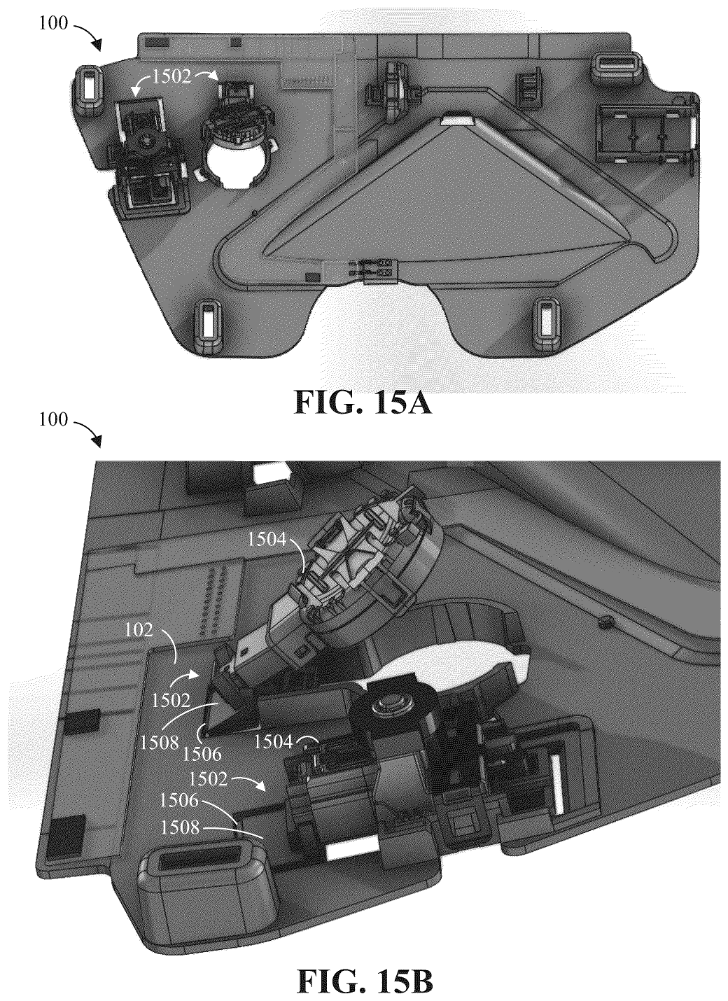

With reference to FIGS. 15A and 15B, an embodiment with a hinge 1502 is shown. In some examples, the hinge 1502 can be disposed on the bracket assembly 100 as shown in FIG. 15A. However, the hinge 1502 can be used in any other assembly or device. In some examples, a device 1504 can be inserted onto or into the hinge 1502. In some examples, the hinge 1502 can include electrical connections and be electrically coupled with a circuit in or on the bracket body 102 when the device 1504 is inserted onto or into the hinge 1502. In some examples, the circuit can be a flexible circuit or any suitable circuit on or in the bracket body 102. In some examples, the hinge 1502 connected to the device 1504 can move the device 1504 based on a joint 1506 of the hinge 1504. In some examples, the hinge 1502 can include a first member 1508 configured to be connected to the device 1504, a second member (not shown in FIG. 15) configured to be connected to the bracket body 102, and the joint 1506 connecting the first member 1508 and the second member such that the first and second members can rotate relative to each other about the joint 1506. In further examples, the second member can be part of the bracket body 102. Thus, the device can be easily inserted onto the hinge 1502 with an angle relative to a surface of the bracket body 102. For example, the device can be inserted with a 45-degree angle, a 30-degree angle, a 60-degree angle, or any suitable degree angle relative to the bracket body 102. In further examples, after the device is inserted onto or into the hinge 1504, the device 1504 can move toward the surface of the bracket body 102 to be fixed onto the bracket body 102. In some examples, a user can press the device 1504 toward the bracket body 102 until a fastener (e.g., a retaining clip) between the bracket body 102 and the device 1504 is engaged.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A bracket, comprising:
a bracket material layer; and
a cell foam attached to the bracket material layer for directing heat from a heating element toward glass,
wherein the heating element is attached to the cell foam for raising a temperature of the glass disposed on or over the heating element.

2. The bracket of claim 1, wherein the cell foam comprises at least one of a closed cell foam or an open cell foam.

3. The bracket of claim 2, wherein the closed cell foam includes a plurality of isolated pores, and
wherein the open cell foam includes a plurality of connected pores.

4. The bracket of claim 2, wherein the closed cell foam includes one or more pockets to create a non-uniform surface.

5. The bracket of claim 1, wherein the cell foam is made of a rubber compound.

6. The bracket of claim 1, wherein the glass is disposed over the heating element to heat the glass by transferring heat from the heating element to the glass by convection.

7. The bracket of claim 1, wherein the glass is disposed on the heating element to heat the glass by conduction.

8. A bracket, comprising:
a bracket material layer comprising a plurality of openings for directing heat from a heating element toward glass,
wherein the heating element is disposed on the bracket material layer for raising a temperature of the glass disposed on or over the heating element.

9. The bracket of claim 8, further comprising:
an adhesive layer attached between the heating element and the bracket material layer for directing the heat from the heating element toward the glass.

10. The bracket of claim 8, wherein each opening of the plurality of openings comprises an aperture passing through the bracket material layer and the heating element.

11. The bracket of claim 8, wherein each opening of the plurality of openings comprises a cavity on a surface of the bracket material layer, the surface of the bracket material layer being disposed on the heating element.

12. The bracket of claim 11, wherein the bracket material layer further comprises a plurality of ribs on a surface of the bracket material layer,
wherein the plurality of openings is formed by the plurality of ribs, and
wherein the plurality of ribs of the bracket material layer is attached to the heating element.

13. The bracket of claim 12, wherein the plurality of openings formed by the plurality of ribs has a grid shape, and
wherein each of the plurality of openings has a polygon shape.

14. The bracket of claim 8, wherein the bracket material layer comprises a glare shield panel and a side wall attached to the glare shield panel, and
wherein the plurality of openings is disposed on at least one of the glare shield panel or the side wall.

15. A bracket, comprising:
a bracket material layer;
an adhesive layer attached to the bracket material layer; and
a fiber material layer attached to the bracket material layer via the adhesive layer for mitigating glare on the bracket material layer.

16. The bracket of claim 15, further comprising:
a coating layer on the bracket material layer to mitigate the glare.

17. The bracket of claim 15, further comprising:
a heating element disposed between the bracket material layer and the adhesive layer.

18. The bracket of claim 17, wherein the heating element on the bracket material layer is configured to raise a temperature of the glass disposed on or over the heating element.

19. The bracket of claim 15, wherein the fiber material layer comprises a flock fiber material.

20. The bracket of claim 19, wherein the fiber material layer comprises at least one of a felt fiber material, a microfiber material, or a cloth fiber material.
